(19) United States
(12) Patent Application Publication
(10) Pub. No.: US 2026/0201972 A1
(43) Pub. Date: Jul. 16, 2026

(54) RISING STEM SEALED BONNET ASSEMBLY

(71) Applicant: ITT Engineered Valves, LLC, Lancaster, PA (US)

(72) Inventors: Chong Yi, Mechanicsburg, PA (US); Timothy Cassel, Manheim, PA (US); Stephen T. Donohue, East Petersburg, PA (US); Nang Chau, Lancaster, PA (US)

(21) Appl. No.: 19/447,535

(22) Filed: Jan. 13, 2026

Related U.S. Application Data
(60) Provisional application No. 63/745,941, filed on Jan. 16, 2025.

(51) Int. Cl. F16K 27/02; F16K 31/50; F16K 7/12

(52) U.S. Cl. CPC F16K 27/0236; F16K 31/50; F16K 7/126

(57) ABSTRACT

A bonnet assembly that includes a handwheel, a stem in contact with the handwheel, a bushing in contact with the stem, an O-ring between the handwheel and the stem, a bonnet housing, and a compressor. The stem includes a spindle and an end. The bonnet housing includes at least one partial internal rib and an overhang lip. The end is configured to attach the stem directly to the compressor.

### CROSS-REFERENCE TO RELATED APPLICATIONS

This application claims the benefit of and priority to U. S. Provisional Patent Application No. 63/745,941 filed on January 16, 2025, the entire contents of which are incorporated by reference herein.

### TECHNICAL FIELD

The present disclosure generally relates to a sealed bonnet for a valve assembly, where sealing occurs at the top of the handwheel to prevent dust and water from entering into the thread working area.

### BACKGROUND

Unless otherwise indicated herein, the materials described in this section are not prior art to the claims herein and are not admitted as being prior art by inclusion in this section.

Valves may be used in industries such as oil and gas. A valve may control a flow of a fluid through a body of the valve. A bonnet covers the opening on top of a valve body and is connected to the valve body. The bonnet interacts with the operating fluid (via a diaphragm which flexes up and down) and is exposed to operating pressure and corrosive effects of the fluid.

### SUMMARY

Existing challenges associated with bonnet assemblies, are overcome by the presently disclosed rising stem sealed bonnet assembly. One embodiment of the present disclosure is a bonnet assembly that includes a handwheel, a stem in contact with the handwheel, a bushing in contact with the stem, an O-ring between the handwheel and the stem, a bonnet housing, and a compressor. The stem includes a spindle and an end. The bonnet housing includes at least one partial internal rib and an overhang lip. The end is configured to attach the stem directly to the compressor.

In aspects, the end of the stem is a T-shaped end or a pin receiving end.

In aspects, the bonnet housing further includes a handwheel tie bar defining a tie hole and the tie hole is configured to receive a tie wrap, chain, or rope threaded through the tie hole and secured to the handwheel to prevent the handwheel from turning.

In aspects, the bonnet assembly further includes a hex lock nut on the spindle of the stem wherein the hex lock nut provides a travel stop to the stem.

In aspects, the O-ring provides a seal between the handwheel and the stem.

In aspects, the handwheel is attached to the bushing by side set screws.

In aspects, a top portion of the bonnet housing has an angular profile configured to provide improved structural strength.

In aspects, the bonnet housing includes one to eight partial internal ribs, each partial internal rib having a height of about 30% of a height of the bonnet housing, the partial internal ribs configured to align the compressor within the bonnet housing and to prevent rotation of the compressor.

In aspects, the bonnet assembly further includes at least one sealed set screw on a base of the handwheel and the at least one sealed set screw is configured as a pressure relief set screw and when opened releases pressure within an upper bushing cavity and a handwheel cavity of the bonnet assembly to contain the pressures caused when a diaphragm is torn.

In aspects, the bonnet assembly further includes at least one mechanical set screw and the at least one mechanical set screw is configured to maintain mechanical stability of the handwheel when the at least one sealed set screw is opened.(mechanical set screws to hold handle from internal pressures)

In aspects, the bonnet assembly includes two sealed set screws, and two mechanical set screws and the sealed set screws are located on opposite sides of a base of the handwheel, and the mechanical set screws are located on opposite sides of the base of the handwheel.

In aspects, the sealed set screws and mechanical set screws are arranged so that an operator may relieve internal pressure of the bonnet assembly by removing the sealed set screws one at a time while the mechanical set screws remain in place.

In aspects, the O-ring is a first O-ring, and the bonnet assembly further includes a second O-ring between the bonnet housing and the bushing and a third O-ring between the bushing and the stem and the second and third O-rings seal a bushing cavity and a handwheel cavity of the bonnet assembly in the event of a tear in a diaphragm. (depends of the valve size)

In aspects, the end of the stem is a T-shaped end and is a T-slot configured to be received by an aperture of the compressor.

In aspects, the end of the stem is a pin receiving end, the bonnet assembly further comprising a pin, wherein the pin receiving end includes a pin aperture configured to receive at least part of the pin, the compressor includes a first aperture configured to receive the pin receiving end and a second aperture configured to receive at least part of the pin, wherein the pin is positioned within the pin aperture of the pin receiving end and the second aperture of the compressor to attach the compressor to the stem.

Another embodiment of the present disclosure is a bonnet assembly that includes a handwheel, a stem in contact with the handwheel including a spindle and a T-shaped or pin receiving end, a bushing, a handwheel tie bar defining a tie hole, a bonnet housing including at least one partial internal rib and an overhang lip, a first O-ring between the handwheel and the stem, a second O-ring between the bonnet housing and the bushing, a third O-ring between the bushing and the stem, and a compressor. The T-shaped or pin receiving end is configured to attach the stem directly to the compressor. The second and third O-rings seal a bushing cavity and a handwheel cavity of the bonnet assembly in the event of a tear in a diaphragm.

In aspects, the bushing includes internal threads configured to engage threads of the stem such that rotation of the handwheel causes rotation of the bushing and axial translation of the stem.

In aspects, the bonnet assembly is sized from 0.5 inches to 2.0 inches.

Another embodiment of the present disclosure is a bonnet assembly that includes a handwheel, a stem including a spindle and a T-shaped or pin receiving end, a bushing, a handwheel tie bar defining a tie hole, a bonnet housing including at least one partial internal rib and an overhang lip, an O-ring between the bonnet housing and the bushing, at least one sealed set screw on a base of the handwheel, at least one mechanical set screw on the base of the handwheel, and a compressor. The T-shaped or pin receiving end is configured to attach the stem directly to the compressor. The at least one sealed set screw is configured as a pressure relief set screw and when opened releases pressure within upper bushing and handwheel cavities of the bonnet assembly caused when a diaphragm is torn. The at least one mechanical set screw is configured to maintain mechanical stability of the handwheel when the at least one sealed set screw is opened.

In aspects, the bonnet assembly is sized from 2.5 inches to 6.0 inches.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a side cross sectional view of a rising stem sealed bonnet assembly in accordance with the present disclosure;

FIG. 2A is a side cross sectional view of a rising stem sealed bonnet assembly in a closed position in accordance with the present disclosure;

FIG. 2B is a side cross sectional view of a rising stem sealed bonnet assembly in an open position in accordance with the present disclosure;

FIG. 3 is a side cross-sectional view of a rising stem sealed bonnet assembly in accordance with the present disclosure;

FIG. 4 is a side cross sectional view of a rising stem sealed bonnet assembly in accordance with the present disclosure; and

FIG. 5 is a side view of a rising stem sealed bonnet assembly in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

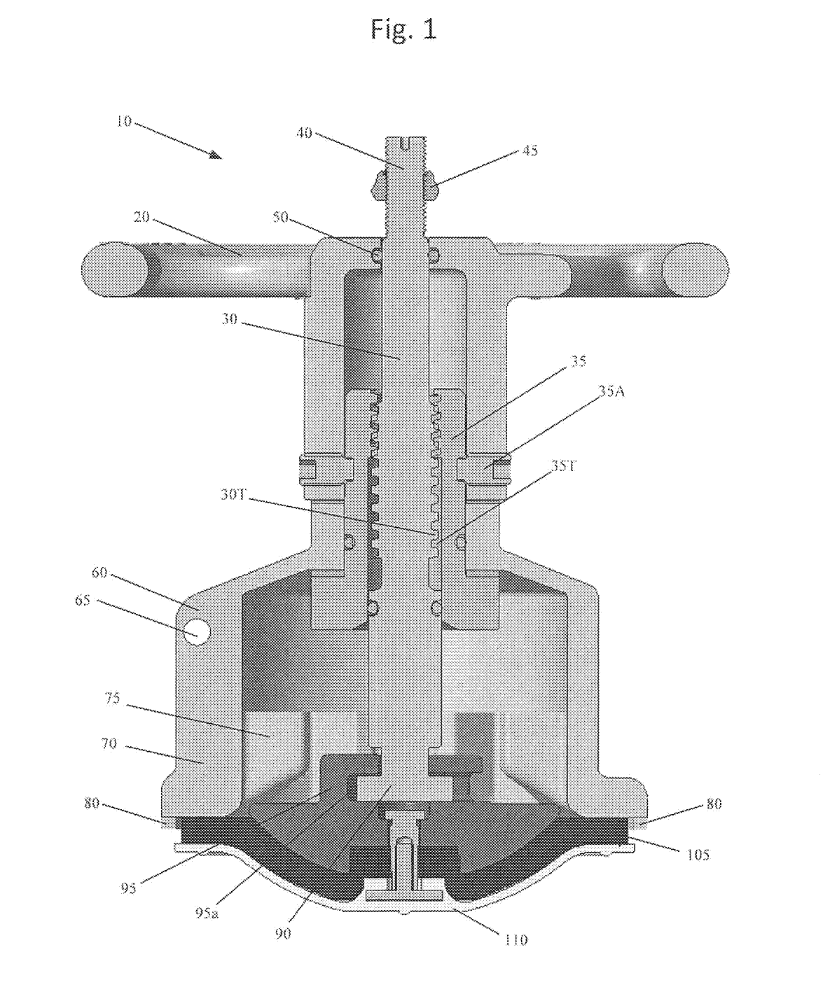

FIG. 1 is a side cross sectional view of a rising stem sealed bonnet assembly in accordance with at least some embodiments described herein. Bonnet assembly 10 may include a handwheel 20, a stem 30, a bushing 35, a spindle 40, an O-ring 50, a handwheel tie bar 60, a tie hole 65, a bonnet housing 70, at least one partial internal rib 75, an overhang lip 80, a T-shaped end 90, and a compressor 95. Stem 30 may be in contact with handwheel 20. Bushing 35 may be in contact with stem 20.

Handwheel 20 may be attached to bushing 35 by side set screws 35A. Bushing 35 may include threads 35T which may interconnect with threads 30T of stem 30. Stem 30 may be a rising stem. When handwheel 20 is turned, bushing 35 may rotate and threads 35T may interact with threads 30T and may move stem 30 and spindle 40 up and down depending on the direction of the rotation.

A top of a valve may be sealed to prevent external contaminants and leaking of internal fluids. O-ring 50 of bonnet assembly 10 may be located within a trunk of handwheel 20 and may form a seal between handwheel 20 and stem 30. O-ring 50 may save vertical space for bonnet assembly 10 and prevent the necessity of additional sealing components such as components that are mounted to the handwheel, a top cover, or an internal component that is threaded on to the bushing.

Bonnet assembly 10 may include a handwheel locking component built into bonnet housing 70. Bonnet housing 70 may include handwheel tie bar 60, which may be an extended external rib. Handwheel tie bar 60 may define tie hole 65, which may be a hole machined through handwheel tie bar 60 which may be configured to receive a tie wrap, chain, or rope threaded through tie hole 65 and secured to handwheel 20 to prevent handwheel 20 from turning. Tie bar 60 with tie hole 65 may allow a user to secure a position of handwheel 20 without requiring a separate component being attached to the bonnet.

Spindle 40 of stem 30 may include a hex lock nut 45. Hex lock nut 45 may be clearly visible and may provide a travel stop for stem 30. A travel stop may be set with hex lock nut 45 when the valve is closed or sealed and may prevent overtightening due to further turning of handwheel 20 which may deform diaphragm 110 and reduce the life and function of the valve. Travel stop provided by hex lock nut 45 may protect a plastic diaphragm from being overstressed or over compressed. Hex lock nut 45 may be adjustable and may be set at the manufacture site or in the field. Hex lock nut 45 may provide a visual indicator of whether the valve is open or closed without requiring a clear top cap enclosing the top of the spindle.

A top of bonnet housing 70 may have an angular profile which may provide improved structural strength over traditional curved profile bonnet housings. Bonnet housing 70 may include at least one, and up to eight, partial internal ribs 75 which may provide structural support to bonnet housing 70 and may require less material than traditional internal ribs which span the entire height of bonnet housing 70. Partial internal ribs 75 may be constructed from metal including cast iron, ductile iron, and stainless steel. Partial internal ribs may have a height of about 30 % of bonnet housing 70. Partial internal ribs 75 may provide a means for aligning compressor 95 within bonnet housing 70 and may prevent compressor 95 from rotating within bonnet housing 70.

Bonnet housing 70 may further include overhang lip 80 which may prevent an elastomer 105 of diaphragm 110 from spreading past the edge of bonnet housing 70 and prevent deformation of elastomer 105 and diaphragm 110 and reduce the life and function of the valve. Overhang lip 80 may extend down from bonnet housing 70 and may extend a distance of up to 30% of a thickness of backing cushion elastomer 105.

Stem 30 may include a T-slot or T-shaped end 90 which may be configured to attach stem 30 directly to compressor 95. Compressor 96 may include an aperture 95a configured to receive T-shaped end 90 of stem 30. T-shaped end 90 of stem 30 may be configured to be secured within aperture 95a of compressor 95 to attach stem 30 with compressor 95. Compressor 95, attached to T-shaped end 90 of stem 30 may be in contact with and compress a diaphragm 110 of the valve.

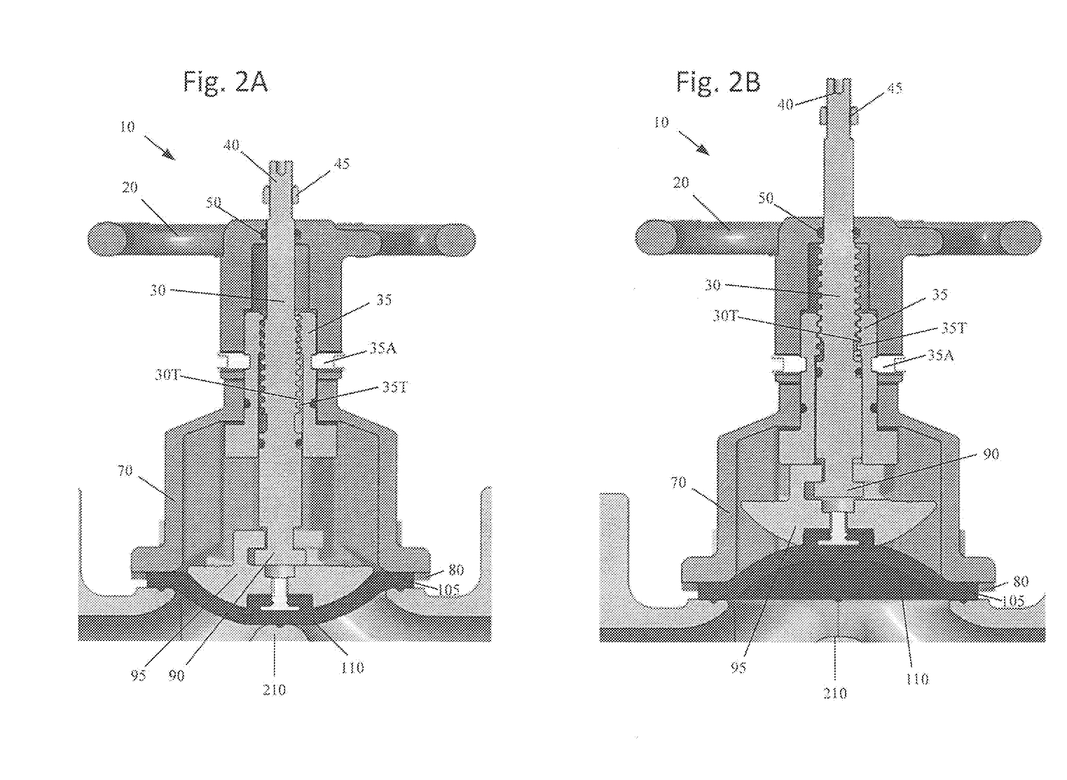

FIG. 2A is a side cross sectional view of a rising stem sealed bonnet assembly in a closed position and FIG. 2B is a side cross sectional view of a rising stem sealed bonnet assembly in an open position in accordance with at least some embodiments described herein. Those components in FIG. 2A and FIG. 2B that are labeled identically to components of FIG. 1 will not be described again for the purposes of brevity.

Stem 30 may include a T-slot or T-shaped end 90 which may be configured to attach stem 30 directly to compressor 95. Compressor 95, attached to T-shaped end 90 of stem 30 may compress a diaphragm 110 of the valve to a valve body 210 to close the valve when handwheel 20 is rotated to a closed position as shown in FIG. 2A. Compressor 95, attached to T-shaped end 90 of stem 30 may decompress diaphragm 110 of the valve away from valve body 210 to open the valve when handwheel 20 is rotated to an opened position as shown in FIG. 2B. Compressor 95 may compress/decompress against diaphragm 110 to open and close and control an amount of fluid through the valved based on a position of stem 30 and rotation of handwheel 20.

As shown in FIG. 2A and FIG. 2B, hex lock nut 45 may be clearly visible and may provide a visual indicator of whether the valve is open or closed. Hex lock nut 45 may also provide a travel stop function and may be set when the valve is closed at FIG. 2A to prevent overtightening due to further turning of handwheel 20.

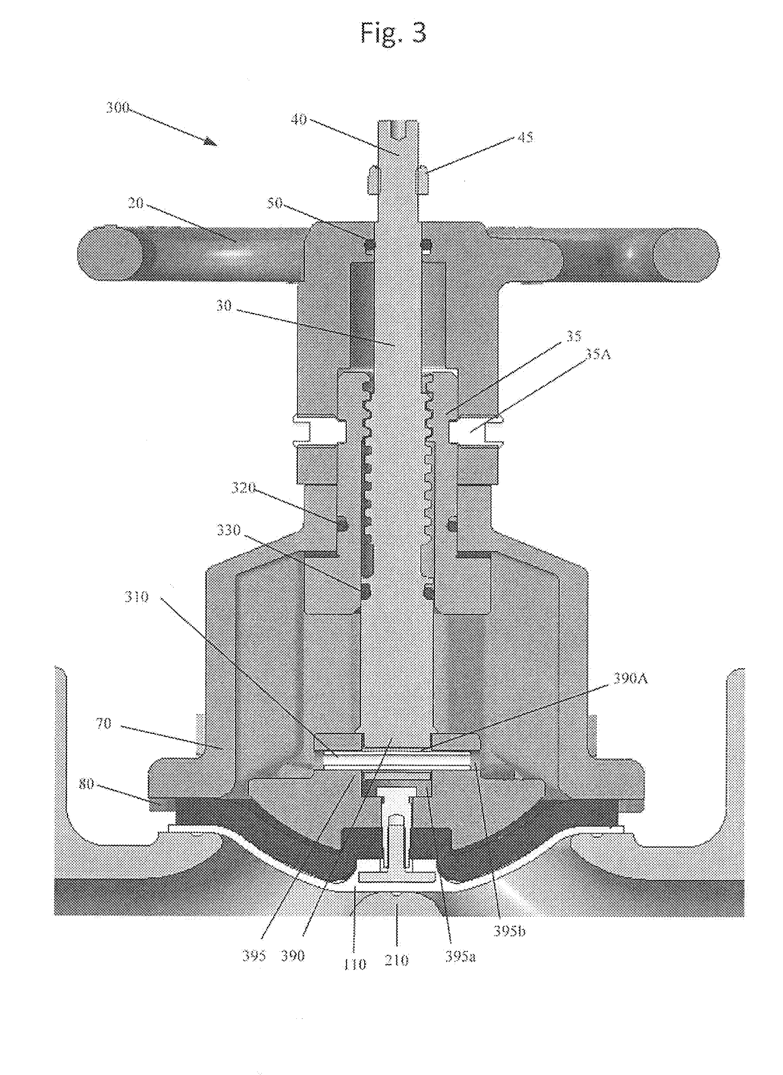

FIG. 3 is a side cross-sectional view of a rising stem sealed bonnet assembly in accordance with at least some embodiments described herein. Those components in FIG. 3 that are labeled identically to components of FIGS. 1-2B will not be described again for the purposes of brevity. Bonnet assembly 300 may include handwheel 20, stem 30, bushing 35, spindle 40, O-ring 50, bonnet housing 70, overhang lip 80, a pin receiving end 390, a pin 310, and a compressor 395. Stem 30 may include pin receiving end 390 which may be configured to attach stem 30 directly to compressor 395. Pin receiving end 390 may include an aperture 390A configured to receive at least part of pin 310. Compressor 395 may be configured to be attached to pin receiving end 390 and may include a first aperture 395a configured to receive pin receiving end 395. Compressor 395 may further include a second aperture 395b configured to receive at least part of pin 310. Pin 310 may be positioned within aperture 390A of pin receiving end 390 and second aperture 395b of compressor 395 and attached compressor 395 to stem 30. Compressor 395 attached to pin receiving end 390 of stem 30 with pin 310 may compress diaphragm 110 of the valve to valve body 210 to close the valve when handwheel 20 is rotated to a closed position as shown in FIG. 3. Compressor 395, attached to pin receiving end 390 of stem 30 may decompress diaphragm 110 of the valve away from valve body 210 to open the valve when handwheel 20 is rotated to an opened position. Compressor 395 may compress/decompress against diaphragm 110 to open, close, and control an amount of fluid through the valved based on a position of stem 30 and rotation of handwheel 20.

In an embodiment, bonnet assembly 300 may be 0.5 inch to 2.0 inch bonnet assembly. In such an embodiment, bonnet assembly 300 may include O-rings 320 and 330 between bonnet housing 70 and bushing 35 and between bushing 35 and stem 30. O-rings 320 and 330 may seal the bushing and handwheel cavities of bonnet assembly 300 in case of a tear in diaphragm 110. O-rings 320 and 330 may insure that all internal fluid of bonnet assembly 300 is contained and that fluid does not pressurize the bushing and handwheel cavities of bonnet assembly 300.

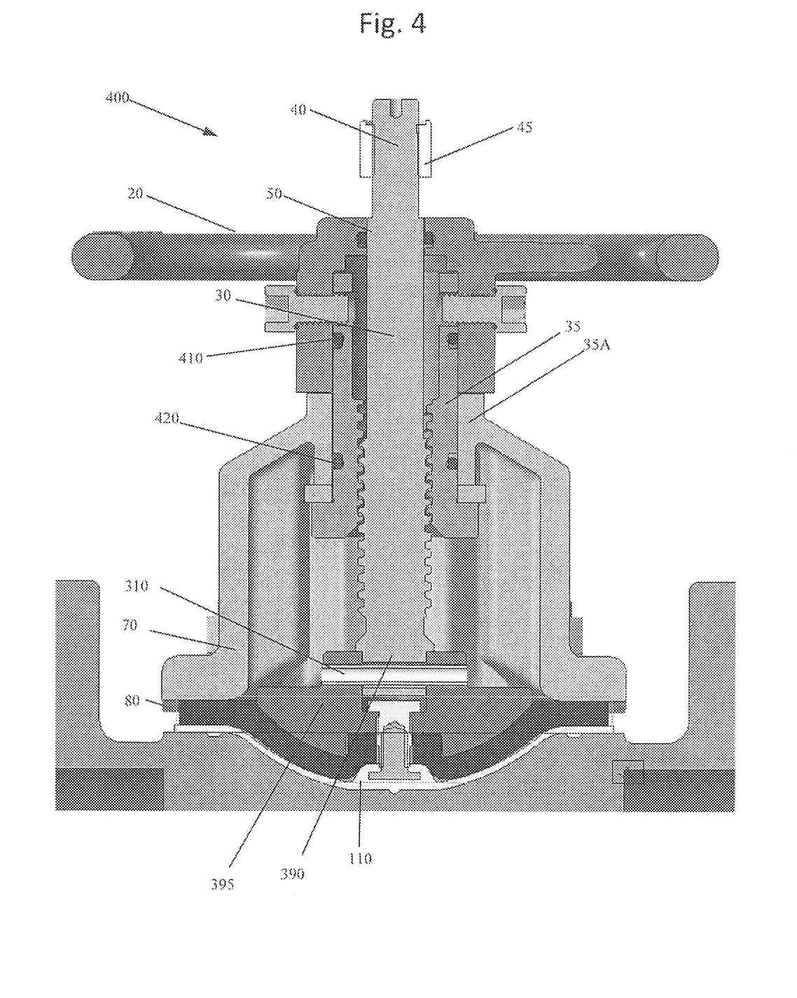

FIG. 4 is a side cross-sectional view of a rising stem sealed bonnet assembly in accordance with at least some embodiments described herein. Those components in FIG. 4 that are labeled identically to components of FIGS. 1-3 will not be described again for the purposes of brevity.

In an embodiment, bonnet assembly 400 may be a 2.5 inch to 6.0 inch bonnet assembly. In such an embodiment, bonnet assembly 400 may include O-rings 410 and 420. Bonnet assembly 400 may not include an O-ring between stem 30 and bushing 35. In an instance when there is a tear in diaphragm 110, the upper bushing and handwheel cavities may become pressurized by fluid traversing torn diaphragm 110. As shown below, bonnet assembly 400 may include sealed set screws and mechanical set screws for releasing this pressure.

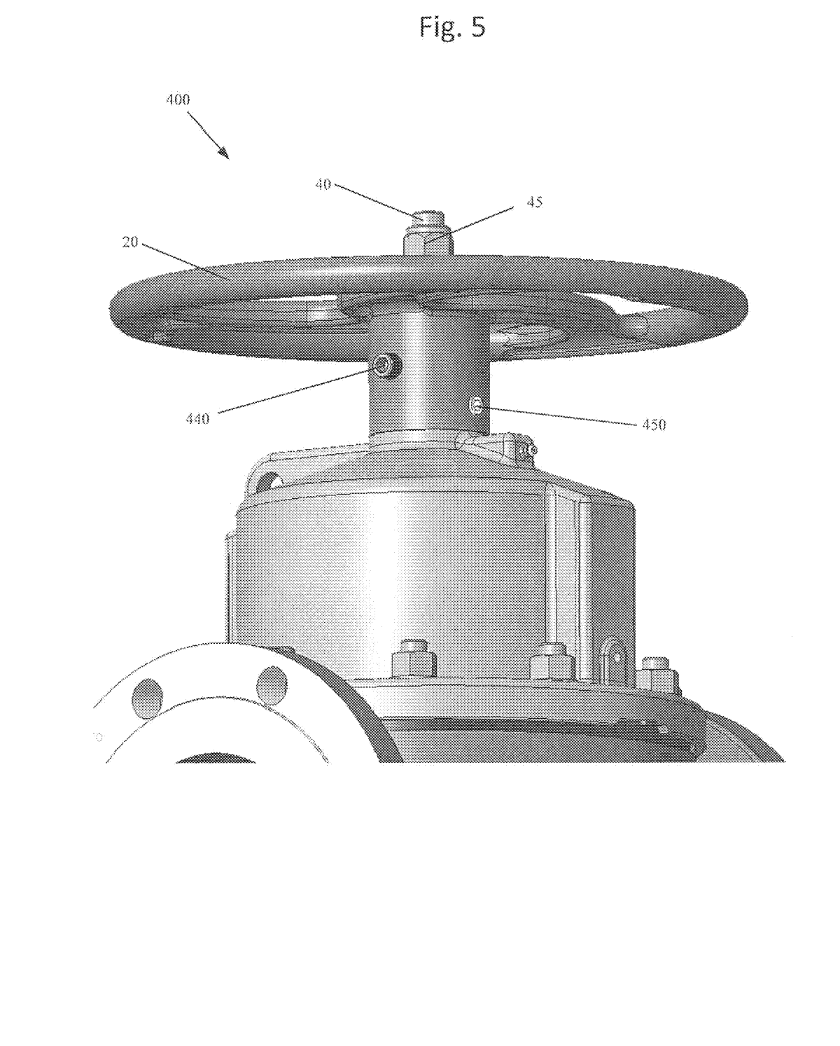

FIG. 5 is a side view of a rising stem sealed bonnet assembly in accordance with at least some embodiments described herein. Those components in FIG. 5 that are labeled identically to components of FIGS. 1-5 will not be described again for the purposes of brevity.

In an embodiment when bonnet assembly 400 is a 2.5 inch to 6.0 inch bonnet assembly, bonnet assembly 400 may include sealed set screws 440 on opposite sides of a base of handwheel 20 and mechanical set screws 450 on opposite sides of a base of handwheel 20. A height of bonnet assembly 400 may be minimized by not including an O-ring between bushing 35 and handwheel 30, but may allow fluid to enter into upper bushing and handwheel cavities of bonnet assembly 400 in the event of a tear in diaphragm 110 (FIG. 4). Sealed set screws 440 may be pressure relief set screws and may be opened to release pressure within the upper bushing and handwheel cavities of bonnet assembly 400 when there is a tear in diaphragm 110 (FIG. 4) and bonnet assembly 10 becomes pressurized by fluid traversing torn diaphragm 110. Mechanical set screws 450 may maintain a stability of bonnet assembly 400 when sealed set screws 440 are opened.

In an example, when diaphragm 110 is ruptured, an operator may relieve inside pressure of bonnet assembly 400 by removing pressure relief screws 440 one by one while mechanical set screws 450 remain in place. Mechanical set screws 450 will maintain mechanical stability and hold handwheel 20 in place. In another example, if the operator removes mechanical set screws 450 first, then the operator may remove only one of pressure relief screws 440 to relieve inside pressure of bonnet assembly 400 and the other pressure relief screw 440 may hold handwheel 20 in place. The pressure relief screws 440 are configured with a safety fallback so that if an operator mistakenly removes mechanical set screws 450 first, one pressure relief screw 440 may hold handwheel 20 in place, when the other pressure relief screw 440 is removed to relieve inside pressure of bonnet assembly 400.

A device in accordance with the present disclosure may provide a bonnet assembly which is sealed to prevent external contaminants and leaking of internal fluids by an O-ring 50 located within a trunk of the handwheel. A device in accordance with the present disclosure may provide a bonnet assembly which does not require additional sealing components such as components that are mounted to the handwheel, a top cover, or an internal component that is threaded on to the bushing. A device in accordance with the present disclosure may provide a bonnet assembly which includes a handwheel locking bar on the bonnet to allow a user to secure a position of the handwheel without requiring a separate component being attached to the bonnet. A device in accordance with the present disclosure may provide a bonnet assembly which includes a lock nut for travel stop function to prevent diaphragm deformation as well as a visual indicator of whether the valve is open or closed without requiring a clear top cap enclosing the top of the spindle.

A device in accordance with the present disclosure may provide a bonnet assembly with a stem that attaches directly to a compressor. A device in accordance with the present disclosure may provide a bonnet assembly with a bonnet housing which has an angular profile to provide improved structural strength over traditional curved profile bonnet housings. A device in accordance with the present disclosure may provide a bonnet assembly with a bonnet housing with partial internal ribs for structural support which require less material than traditional internal ribs which span the entire height of a standard bonnet housing. A device in accordance with the present disclosure may provide a bonnet assembly with an overhang lip to prevent an elastomer of the diaphragm from spreading past the edge of the bonnet housing.

Further, a device in accordance with the present disclosure may provide a bonnet assembly with at least one sealed set screw is configured as a pressure relief set screw and when opened releases pressure within upper bushing and handwheel cavities of the bonnet assembly caused when a diaphragm is torn. A device in accordance with the present disclosure may provide a bonnet assembly with at least one mechanical set screw is configured to maintain mechanical stability of the handwheel when the at least one sealed set screw is opened.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A bonnet assembly comprising:
a handwheel;
a stem in contact with the handwheel including a spindle and an end;
a bushing in contact with the stem;
an O-ring between the handwheel and the stem;
a bonnet housing including at least one partial internal rib and an overhang lip; and
a compressor;
wherein the end is configured to attach the stem directly to the compressor.

2. The bonnet assembly of claim 1, wherein the end of the stem is a T-shaped end or a pin receiving end.

3. The bonnet assembly of claim 1, wherein the bonnet housing further includes a handwheel tie bar defining a tie hole and the tie hole is configured to receive a tie wrap, chain, or rope threaded through the tie hole and secured to the handwheel to prevent the handwheel from turning.

4. The bonnet assembly of claim 1, further comprising a hex lock nut on the spindle of the stem wherein the hex lock nut provides a travel stop to the stem.

5. The bonnet assembly of claim 1, wherein the O-ring provides a seal between the handwheel and the stem.

6. The bonnet assembly of claim 1, wherein the handwheel is attached to the bushing by side set screws.

7. The bonnet assembly of claim 1, wherein a top portion of the bonnet housing has an angular profile configured to provide improved structural strength.

8. The bonnet assembly of claim 1, wherein the bonnet housing includes one to eight partial internal ribs, each partial internal rib having a height of about 30% of a height of the bonnet housing, the partial internal ribs configured to align the compressor within the bonnet housing and to prevent rotation of the compressor.

9. The bonnet assembly of claim 1, further comprising at least one sealed set screw on a base of the handwheel, wherein the at least one sealed set screw is configured as a pressure relief set screw and when opened releases pressure within an upper bushing cavity and a handwheel cavity of the bonnet assembly caused when a diaphragm is torn.

10. The bonnet assembly of claim 9, further comprising at least one mechanical set screw, wherein the at least one mechanical set screw is configured to maintain mechanical stability of the handwheel when the at least one sealed set screw is opened.

11. The bonnet assembly of claim 10, wherein the bonnet assembly includes two sealed set screws, and two mechanical set screws and the sealed set screws are located on opposite sides of a base of the handwheel, and the mechanical set screws are located on opposite sides of the base of the handwheel.

12. The bonnet assembly of claim 11, wherein the sealed set screws and mechanical set screws are arranged so that an operator may relieve internal pressure of the bonnet assembly by removing the sealed set screws one at a time while the mechanical set screws remain in place.

13. The bonnet assembly of claim 1, wherein the O-ring is a first O-ring, the bonnet assembly further comprising a second O-ring between the bonnet housing and the bushing and a third O-ring between the bushing and the stem, wherein the second and third O-rings seal a bushing cavity and a handwheel cavity of the bonnet assembly in the event of a tear in a diaphragm.

14. The bonnet assembly of claim 2, wherein the end of the stem is a T-shaped end and is a T-slot configured to be received by an aperture of the compressor.

15. The bonnet assembly of claim 2, wherein the end of the stem is a pin receiving end, the bonnet assembly further comprising a pin, wherein the pin receiving end includes a pin aperture configured to receive at least part of the pin, the compressor includes a first aperture configured to receive the pin receiving end and a second aperture configured to receive at least part of the pin, wherein the pin is positioned within the pin aperture of the pin receiving end and the second aperture of the compressor to attach the compressor to the stem.

16. A bonnet assembly comprising:
a handwheel;
a stem in contact with the handwheel including a spindle and a T-shaped or pin receiving end;
a bushing in contact with the stem;
a handwheel tie bar defining a tie hole;
a bonnet housing including at least one partial internal rib and an overhang lip;
a first O-ring between the handwheel and the stem;
a second O-ring between the bonnet housing and the bushing;
a third O-ring between the bushing and the stem; and
a compressor;
wherein the T-shaped or pin receiving end is configured to attach the stem directly to the compressor and the second and third O-rings seal a bushing cavity and a handwheel cavity of the bonnet assembly in the event of a tear in a diaphragm.

17. The bonnet assembly of claim 16, wherein the bushing includes internal threads configured to engage threads of the stem such that rotation of the handwheel causes rotation of the bushing and axial translation of the stem.

18. The bonnet assembly of claim 16, wherein the bonnet assembly is sized from 0.5 inches to 2.0 inches.

19. A bonnet assembly comprising:
a handwheel;
a stem in contact with the handwheel including a spindle and a T-shaped or pin receiving end;
a bushing in contact with the stem;
a handwheel tie bar defining a tie hole;
a bonnet housing including at least one partial internal rib and an overhang lip;
an O-ring between the bonnet housing and the bushing;
at least one sealed set screw on a base of the handwheel;
at least one mechanical set screw on the base of the handwheel; and
a compressor;
wherein the T-shaped or pin receiving end is configured to attach the stem directly to the compressor, the at least one sealed set screw is configured as a pressure relief set screw and when opened releases pressure within an upper bushing cavity and a handwheel cavity of the bonnet assembly caused when a diaphragm is torn, and the at least one mechanical set screw is configured to maintain mechanical stability of the handwheel when the at least one sealed set screw is opened.

20. The bonnet assembly of claim 19, wherein the bonnet assembly is sized from 2.5 inches to 6.0 inches.
